(19) United States
(12) Patent Application Publication
(10) Pub. No.: US 2012/0086858 A1
(43) Pub. Date: Apr. 12, 2012

(54) DISPLAY AND MULTI-VIEW DISPLAYING SWITCH METHOD THEREOF

(75) Inventors: Tsung-Hsun HAN, Taipei City (TW); Chiao-Jung Lo, Hsinchu City (TW); Hou-Yi Wu, Hsinchu City (TW)

(73) Assignee: NOVATEK MICROELECTRONICS CORP., Hsinchu (TW)

(21) Appl. No.: 13/192,456

(22) Filed: Jul. 27, 2011

Related U.S. Application Data
(60) Provisional application No. 61/390,784, filed on Oct. 7, 2010.

(30) Foreign Application Priority Data
Jan. 25, 2011 (TW) 100102709

(51) Int. Cl. H04N 5/445

(52) U.S. Cl. 348/564; 348/E05.099

(57) ABSTRACT

A multi-view displaying switch method of a display includes the following steps. The display receives multiple channel signals, and captures multiple corresponding static images from the channel signals. The display displays the static images in a first multi-view pattern, and displays one multi-view switch key on the display. When the multi-view switch key is triggered, the display switches the first multi-view pattern to a second multi-view pattern to display the static images.

This application claims the benefits of a provisional application Ser. No. 61/390,784, filed Oct. 7, 2010, and Taiwan application Serial No. 100102709, filed Jan. 25, 2011, the subject matter of which is incorporated herein by reference.

### BACKGROUND

1. Technical Field

The invention relates in general to a display and a multi-view displaying switch method thereof, and more particularly to a display and a multi-view displaying switch method thereof with high convenience.

2. Background

Displays on the current market provide users the function of watching TV shows. If the users want to watch the TV shows, the users usually switches TV channels in sequence to know the shows the TV channels playing and stop at the wanted TV channel. For the users' convenience, some displays provide a pre-view mode to capture displaying frames of the TV channels and then display to the users in a multi-view way, so that the users select a wanted TV channel and utilize a remote controller to switch to the wanted TV channel.

### SUMMARY

The disclosure is directed to a display and a multi-view displaying switch method thereof, capable of benefiting users to fast switch and watch a wanted TV channel by utilizing a multi-view switch key shown on an On Frame Display (OSD) layer.

According to a first aspect of the present disclosure, multi-view displaying switch method of a display is provided. The multi-view displaying switch method of the display includes the following steps. The display receives multiple channel signals, and captures multiple corresponding static images from the channel signals. The display displays the static images in a first multi-view pattern, and displays one multi-view switch key on the display. When the multi-view switch key is triggered, the display switches the first multi-view pattern to a second multi-view pattern to display the static images.

According to a second aspect of the present disclosure, a display is provided. The display includes a panel, a receiver and a control unit. The receiver is for receiving multiple channel signals. The control unit is for capturing multiple corresponding static images from the channel signals, controlling the panel to display the static images in a first multi-view pattern and displaying one multi-view switch key on the panel. When the multi-view switch key is triggered, the panel switches the first multi-view pattern to a second multi-view pattern to display the static images.

The invention will become apparent from the following detailed description of the preferred but non-limiting embodiments. The following description is made with reference to the accompanying drawings.

### BRIEF DESCRIPTION OF THE DRAWINGS

FIG. 1 shows a schematic illustration illustrating a display according to an embodiment.

FIG. 2 shows a flow chart illustrating a multi-view displaying switch method of a display according to an embodiment.

FIG. 3 shows a multi-view schematic illustration of an example of a multi-view displaying switch method of a display according to an embodiment.

FIG. 4 shows a multi-view schematic illustration of another example of a multi-view displaying switch method of a display according to an embodiment.

FIG. 5 shows a multi-view schematic illustration of other example of a multi-view displaying switch method of a display according to an embodiment.

### DETAILED DESCRIPTION OF THE INVENTION

The disclosure proposes a display and a multi-view displaying switch method thereof, capable of benefiting users to fast switch among different multi-view patterns for preview and watch a wanted TV channel by utilizing a multi-view switch key.

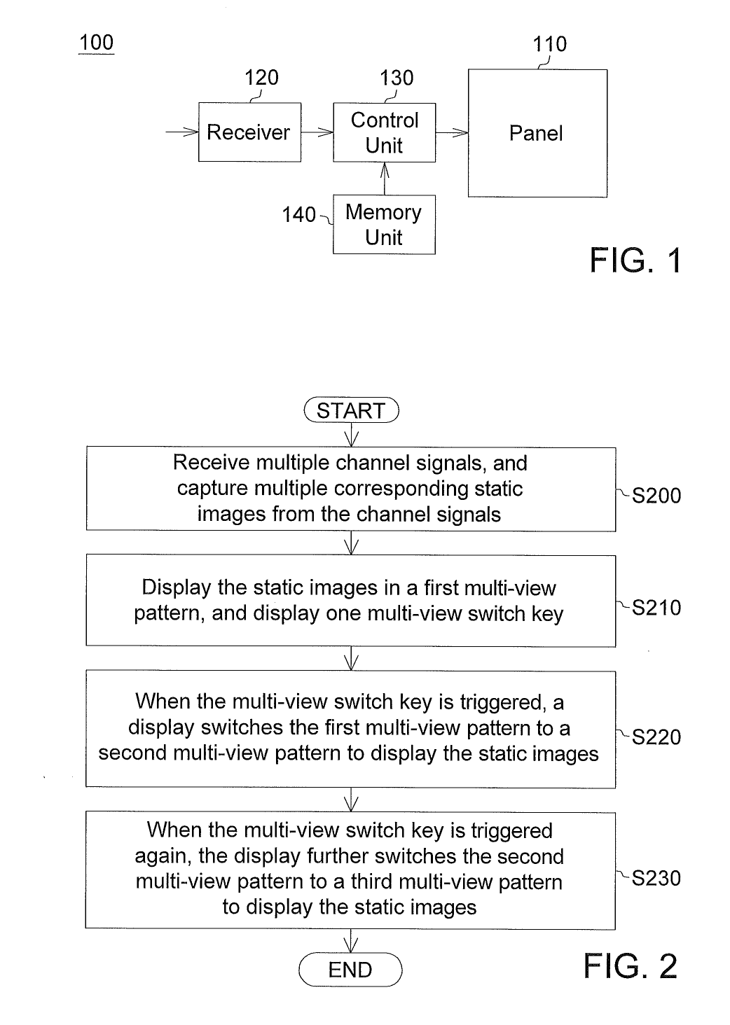

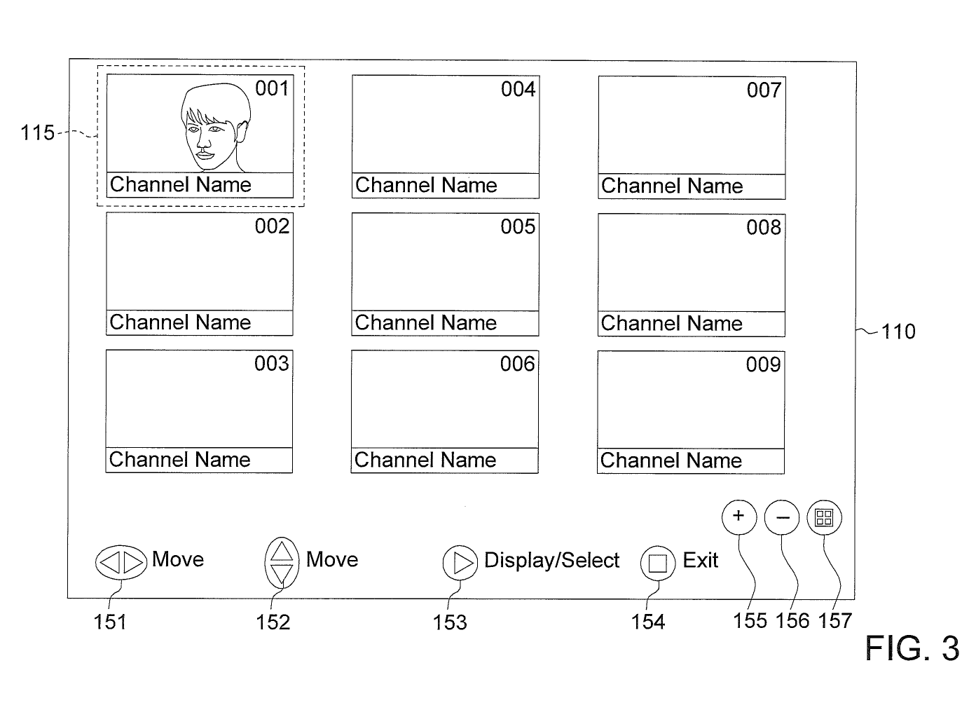

Referring concurrently to FIGS. 1 and 2, FIG. 1 shows a schematic illustration illustrating a display according to an embodiment, and FIG. 2 shows a flow chart illustrating a multi-view displaying switch method of a display according to an embodiment. In FIG. 1, the display 100 includes a panel 110, a receiver 120, a control unit 130 and a memory unit 140. The panel 110 is controlled by the control unit 130. The memory unit 140 is electrically connected to the control unit 130. The memory unit 140 stores multiple different multi-view patterns, such as a 4-frame, a 9-frame, or a (12+1)-frame, but is not limited thereto and is determined according to the design.

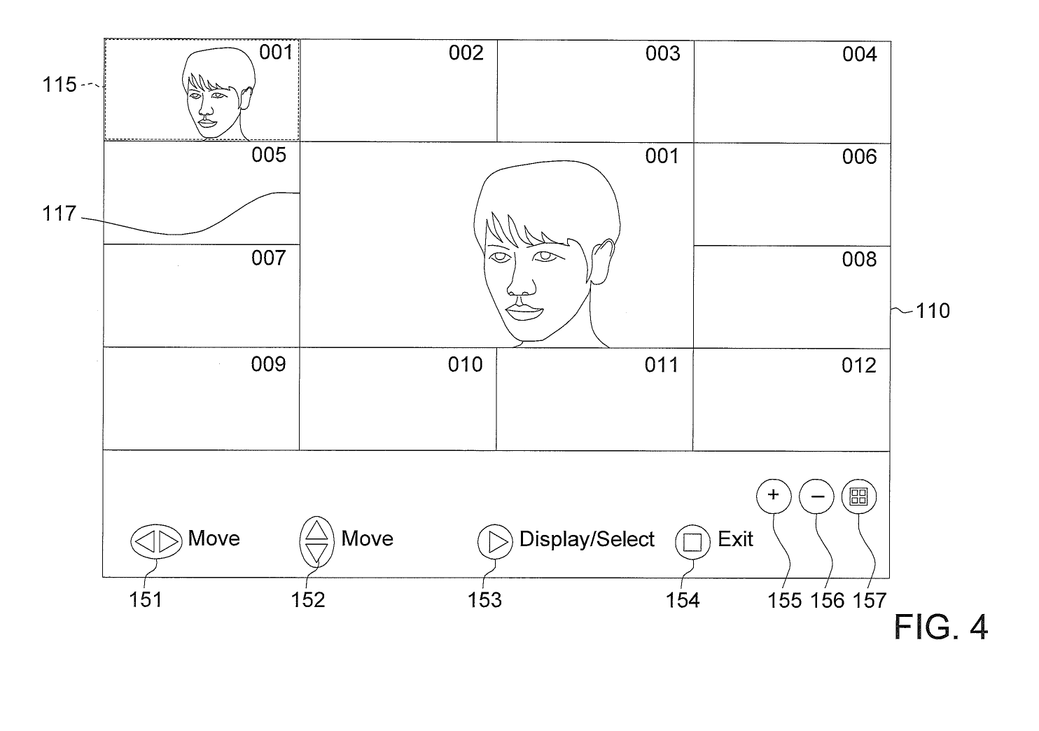

In step S200, the receiver 120 receives multiple channel signals, and the control unit 130 captures multiple corresponding static images from the channel signals. Each static image substantially corresponds to an image frame of the corresponding channel signals at the time being scanned. Next, in step S210, the control unit 130 controls the panel 110 to display the static images in a first multi-view pattern, and displays one multi-view switch key on the panel 110. The first multi-view pattern is, for example, a 9-frame, as shown in FIG. 3, showing a multi-view schematic illustration of an example of a multi-view displaying switch method of a display according to an embodiment.

In FIG. 3, the multi-view switch key 157 is, for example, displayed on an On Frame Display (OSD) layer of the panel 110, but is not limited thereto. The multi-view switch key 157 is used for switching the multiple different multi-view patterns stored in the display 100. In addition, multiple function keys 151 to 156 are also displayed at the same time and not limited to provide a single function. For example, the function keys 151 and 152 may be used to move the selected frame 115, the function key 153 may be used to select an frame or to display, the function key 154 may be used to exit, and the function keys 155 and 156 may be used to switch the static images of around different groups.

As shown in FIG. 3, when the users trigger the function keys 151 and 152, through a remote controller or a touch interface, to move the selected frame 115 to the frame corresponding to the channel 001 and then trigger the function key 153, the display 100 can televise live the channel signal corresponding to the selected static image, that is, the channel signal of the channel 001. The display 100 may televise live the channel signal of the channel 001 either in a full-frame mode or at the original location of the multi-view pattern.

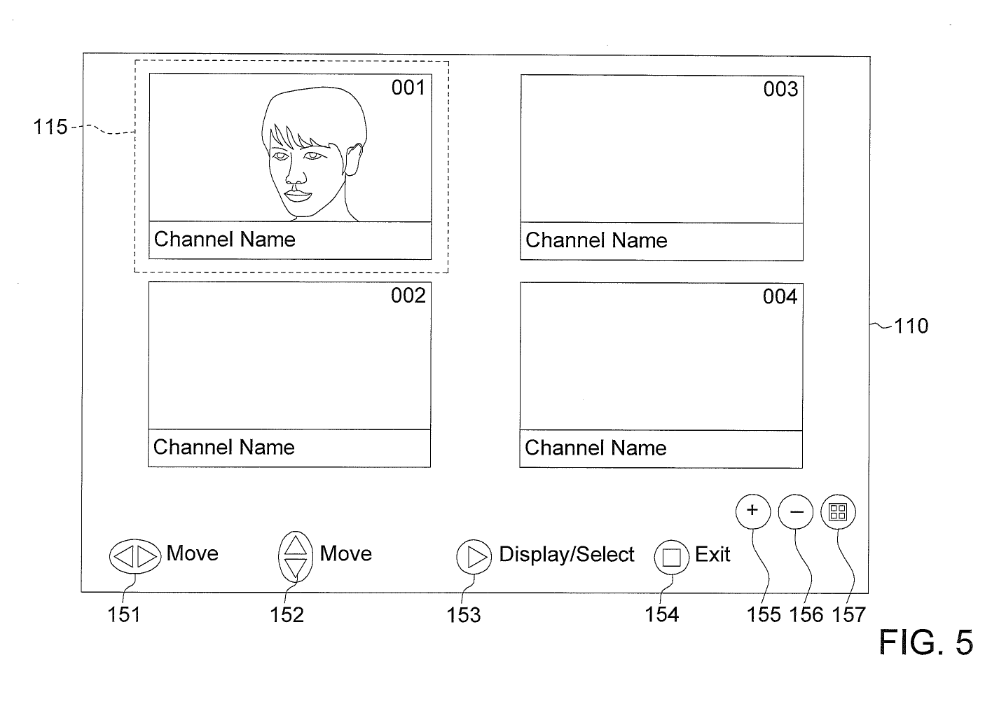

Referring concurrently to FIGS. 4 and 5, FIG. 4 shows a multi-view schematic illustration of another example of a multi-view displaying switch method of a display according to an embodiment, and FIG. 5 shows a multi-view schematic illustration of other example of a multi-view displaying switch method of a display according to an embodiment. Then, in step S220, when the multi-view switch key 157 is triggered, the control unit 130 controls the panel 110 to switch the first multi-view pattern to a second multi-view pattern to display the static images.

The second multi-view pattern is such a (12+1)-frame. After the multi-view switch key 157 is triggered, the multi-view pattern displayed by the display 100 may be switched fast from the 9-frame to the (12+1)-frame, so that a different multi-view pattern is provided to the users for preview and selecting a wanted TV channel. The display 100 can further televise live the image frame corresponding to the selected frame 115 in a specific display area 117 on the panel 110. Furthermore, in step S230, after the multi-view switch key 157 is triggered again, the multi-view pattern displayed by the display 100 may be switched fast from the (12+1)-frame to a 4-frame, so that another different multi-view pattern is provided to the users for preview and selecting a wanted TV channel. Consequently, the users' desire for fast switching the different multi-view patterns for preview is satisfied.

The display and the multi-view displaying switch method thereof proposed in the present disclosure utilizes a multi-view switch key and provides multiple multi-view patterns, so that the users may fast switch among the different multi-view patterns for preview and select a wanted TV channel.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-view displaying switch method of a display, comprising:
receiving a plurality of channel signals and capturing a plurality of corresponding static images from the channel signals;
displaying the static images in a first multi-view pattern, and displaying one multi-view switch key on the display; and
switching the first multi-view pattern to a second multi-view pattern to display the static images when the multi-view switch key is triggered.

2. The multi-view displaying switch method according to claim 1, wherein the first multi-view pattern is a 9-frame, and the second multi-view pattern is a (12+1)-frame.

3. The multi-view displaying switch method according to claim 1, further comprising:
further switching the second multi-view pattern to a third multi-view pattern to display the static images when the multi-view switch key is triggered again.

4. The multi-view displaying switch method according to claim 3, wherein the second multi-view pattern is a (12+1)-frame, and the third multi-view pattern is a 4-frame.

5. The multi-view displaying switch method according to claim 1, wherein the display stores a plurality of different multi-view patterns.

6. A display, comprising:
a panel;
a receiver for receiving a plurality of channel signals; and
a control unit for capturing a plurality of corresponding static images from the channel signals, controlling the panel to display the static images in a first multi-view pattern and displaying one multi-view switch key on the panel;
wherein when the multi-view switch key is triggered, the panel switches the first multi-view pattern to a second multi-view pattern to display the static images.

7. The display according to claim 6, wherein the first multi-view pattern is a 9-frame, and the second multi-view pattern is a (12+1)-frame.

8. The display according to claim 6, wherein when the multi-view switch key is triggered again, the control unit further controls the panel to switch the second multi-view pattern to a third multi-view pattern to display the static images.

9. The display according to claim 8, wherein the second multi-view pattern is a (12+1)-frame, and the third multi-view pattern is a 4-frame.

10. The display according to claim 6, wherein the display further comprises a memory unit to store a plurality of different multi-view patterns.
